(19) United States
(12) Patent Application Publication
(10) Pub. No.: US 2010/0113661 A1
(43) Pub. Date: May 6, 2010

(54) METHOD FOR PREPARING POLYAMIDE POWDER BY ANIONIC POLYMERISATION

(75) Inventors: Holger Senff, Saint Germain en Laye (FR); Christelle Gaboriau, Corneville La Fouquetiere (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/521,082

(22) PCT Filed: Dec. 20, 2007
(86) PCT No.: PCT/FR2007/052584

§ 371 Date: Dec. 28, 2009

(30) Foreign Application Priority Data
Dec. 28, 2006 (FR) 06 56024

(51) Int. Cl. C08L 77/00; C08K 5/5415; C08K 3/38; C08K 3/22; C08K 3/34; C08K 3/36

(52) U.S. Cl. 524/261; 524/404; 524/430; 524/444; 524/606; 525/178; 525/183; 525/184; 525/424

(57) ABSTRACT

The invention relates to a method for preparing a powdered polymer selected from a polyamide, a copolyamide or a copolyesteramide by anionic polymerization in a solvent solution, characterized in that the polymerization of the monomers) generating said polymer is made in the presence of a catalyst, an activator, at least one amide one of which is always a N,N′-alkylene bisamide, and an organic or inorganic filler, the amount of N,N′-alkylene bisamide added in the medium being determined based on the specific surface are desired for the powder particles, said powder particles having an essentially constant diameter or one depending on the desired mean diameter of the powder particles, said powder particles having an essentially constant specific surface area.

Porous powder particles of polyamide, copolyamide or copolyesteramide are spherical or near-spherical particles with an average diameter of less than 100 μm, preferably less than 50 μm. These particles, which have a controlled Apparent Specific Surface Area (ASSA), constitute a major asset in applications such as the following: composite materials, transfer papers, the coating of substrates, especially metallic substrates (coil coating), solid or liquid paint and ink compositions, the agglomeration of polyamide powders by compression with or without metal particles, or by sintering or melting induced by radiation such as, for example, a laser beam (laser sintering), infrared radiation or UV radiation (UV curing), and cosmetic and/or pharmaceutical formulations.

The industrial production of porous polyamide particles, especially spheroidal particles, with a narrow particle-size distribution is known by anionic polymerization of lactam(s) in suspension (FR1213993, FR1602751) or in solution (DE1183680) in an organic liquid. The processes described in these patents allow direct production of polyamide particles which separate by themselves from the liquid medium at the rate at which they are formed. Patent EP0192515 describes the anionic polymerization of a lactam in a stirred reactor in a solvent in the presence of a catalyst, an activator, an N,N′-alkylenebisamide, and, optionally, an organic or inorganic filler. The size of the particles may be compensated by acting on various parameters of the process: the reaction temperature, the amount of catalyst, the rate of injection of the activator, the stirring speed, the filler content.

TABLE A

| | Average diameter | ASSA |
|---|---|---|
| | [μm] | [m²/g] |
| Orgasol ®2002 UD | 5 | 9 |
| Orgasol ®2002 EXD | 10 | 4 |
| Orgasol ®2002 D | 20 | 1.5 |
| Orgasol ®2002 ES3 | 30 | 1 |

The polyamide powder particles on the market show that, for an increasing average diameter, the ASSA reduces, as shown in table A above.

However, in order to respond to the requirement of the market, it is important to produce polyamide, copolyamide or copolyesteramide powder particles which, for a given average diameter, fall within the widest possible range of apparent specific surface area (ASSA), with ASSAs which are preferably as high as possible, or which, for a given ASSA, fall within the widest possible range of average diameter, with average diameters which are preferably as low as possible.

The applicant has now found a solution to this technical problem, and demonstrates below that, to obtain polyamide, copolyamide or copolyesteramide particles with a narrow particle-size distribution, with an average diameter of less than 100 μm, preferably less than 50 μm, advantageously less than 30 μm, even more advantageously less than 20 μm, and with an ASSA of less than 50 m2/g, advantageously less than 40 m2/g, even more advantageously less than 30 m2/g, the anionic polymerization in solution in a solvent of the constituent monomer or monomers of said polymer is carried out in the presence of a catalyst, an activator, at least one amide, of which one is always an N,N′-alkylenebisamide, and an organic or inorganic filler, the amount of N,N′-alkylenebisamide added to the medium being determined as a function of the Apparent Specific Surface Area (ASSA) and/or of the average diameter of the particles it is desired to obtain. This is termed anionic polymerization by seeding with an organic or inorganic filler. This concept of seeding is to be differentiated from the concept of coating which is addressed in the applicant's patent EP196972, and which has nothing to do with the present invention.

Seeding is referred to when the thickness of the polymer layer of the eventual seeded particle is greater than the radius of the filler whose density is not more than 4.5 cm³/g. Conversely, coating is referred to when the thickness of the polymer layer of the eventual coated particle is less than the radius of the filler whose density is not more than 4.5 cm³/g.

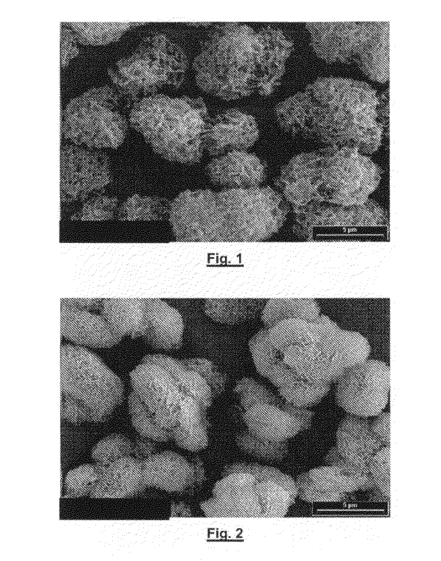

FIG. 1 is a photograph of the powder of the invention obtained in Ex. 1, and

FIG. 2 is a photograph of the powder of the invention obtained in Ex. 2.

The invention provides a process for preparing powder of polymer selected from a polyamide, a copolyamide or a copolyesteramide by anionic polymerization in solution in a solvent, characterized in that said polymerization of the constituent monomer or monomers of said polymer is carried out in the presence:
of a catalyst,
of an activator,
of at least one amide selected from N,N′-alkylenebisamides, and
of an organic or inorganic filler with a maximum density of 4.5 cm3/g,
   the amount of amide added to the reaction medium being determined as a function of the Apparent Specific Surface Area (ASSA) it is desired to obtain for powder particles, said powder particles having a substantially constant diameter.

In one embodiment the process for preparing powder of polymer selected from a polyamide, a copolyamide or a copolyesteramide by anionic polymerization in solution in a solvent is characterized in that said polymerization of the constituent monomer or monomers of said polymer is carried out in the presence:
of a catalyst,
of an activator,
of at least one amide selected from N,N′-alkylenebisamides, and
of an organic or inorganic filler with a maximum density of 4.5 cm3/g,
   the amount of amide added to the reaction medium being determined as a function of the average diameter it is desired to obtain for powder particles, said powder particles having a substantially constant Apparent Specific Surface Area (ASSA).

In one embodiment the process is characterized in that, when the amount of amide goes up, the ASSA goes up.

In one embodiment the process is characterized in that, when the amount of amide goes up, the average diameter goes down.

In one embodiment the process is characterized in that the constituent monomer or monomers of the polymer is or are selected from lactams such as lauryllactam, caprolactam, enantholactam, capryllactam or mixtures thereof, preferably, lauryllactam alone, caprolactam alone or the mixture thereof.

In one embodiment the process is characterized in that the constituent monomers of the polymer are a mixture comprising in molar %, the total being to 100%:
from 1% to 98% of a lactam selected from lauryllactam, caprolactam, enantholactam, and capryllactam;
from 1% to 98% of a lactam other than the first, selected from lauryllactam, caprolactam, enantholactam, and capryllactam;
from 1% to 98% of a lactone selected from caprolactone, valerolactone, and butyrolactone; advantageously 30-46% of caprolactam, 30-46% of lauryllactam, and 8-40% of caprolactone.

In one embodiment the process is characterized in that the catalyst is selected from sodium hydride, potassium hydride, sodium, and sodium methoxide and ethoxide.

In one embodiment the process is characterized in that the activator is selected from lactam N-carboxyanilides, (mono)isocyanates, polyisocyanates, carbodiimides, cyanamides, acyllactams and acylcarbamates, triazines, ureas, N-substituted imides, esters, and phosphorus trichloride. activator is selected from lactam N-carboxyanilides, (mono)isocyanates, polyisocyanates, carbodiimides, cyanamides, acyllactams and acylcarbamates, triazines, ureas, N-substituted imides, esters, and phosphorus trichloride.

In one embodiment the process is characterized in that the N,N′-alkylenebisamide is selected from N,N′-ethylenebisstearamide (EBS) and N,N′-ethylene-bisoleamide (EBO).

In one embodiment the process is characterized in that the inorganic filler is selected from silicas, aluminosilicates, aluminum oxides or alumina, titanium dioxides, and BN.

In one embodiment the process is characterized in that the organic filler is selected from homo- or copolyamide polyamide powders, preferably powders of PA12, PA11, PA6, PA6-12, PA 6,12, PA 6,6, PA8, PA4, of polystyrenes, of polyurethanes, of poly(methyl)methacrylates (PMMA), of polyacrylates, of polyesters, of silicones, of polyethylenes, and of polytetrafluoroethylene.

In one embodiment the process is characterized in that the distribution of the particles is narrower than that of the particles obtained by the process defined above.

In one embodiment the process is characterized in that the powder particles obtained have an average diameter <30 microns, advantageously <20 microns.

In one embodiment the process is characterized in that the ASSA <40 m²/g, advantageously <30 m²/g.

The invention also provides polymer powder particles selected from a polyamide, a copolyamide or a copolyesteramide obtained by the process defined above.

In one embodiment the particles are characterized in that the organic filler is an Orgasol®.

The invention further provides a composition of above particles, characterized in that it further comprises at least one compound selected from carbon nanotubes, metal particles, pigments, dyes, antioxidants, anti-UV agents, plasticizers, and carbon black.

The invention provides, moreover, for the use of the powder particles obtained by the process described above, of the particles described above or of the composition defined above to manufacture composite materials, transfer papers, substrate coatings, particularly on metallic substrates (coil coating), solid or liquid paint or ink compositions, cosmetic compositions and/or pharmaceutical compositions, in one embodiment, to manufacture articles by agglomeration of said powder, alone or in composition, by compression or by sintering or melting induced by radiation such as a laser beam (laser sintering), infrared radiation or UV radiation (UV curing).

A substantially constant diameter means that, for a given process, the average diameter of the particles obtained from one batch to the next may vary within a diameter range of greater than or less than 20% in relation to the average of the average diameters from the different batches. For example, for batches for which the average of the average diameters is 10 μm, the range of variation is between 8 and 12 μm.

A substantially constant ASSA means that, for a given process, the average ASSA of the particles obtained from one batch to the next may vary within an ASSA range of greater than or less than 25% in relation to the average of the average ASSAs from the different batches. For example, for batches for which the average of the ASSAs is 4 m2/g, the range of variation is between 3 and 5 m2/g.

### The Polymerizable Monomer or Monomers

The polymerizable monomer or monomers used in the invention is or are selected from lactams such as, for example, lauryllactam, caprolactam, enantholactam, capryllactam or mixtures thereof. Preference is given to using lauryllactam alone, caprolactam alone, or the mixture thereof.

It is also possible to consider the copolymerization of two or more lactams with a lactone, leading to a copolyesteramide, as described in patent EP1172396. In this case the mixture copolymerized is a mixture comprising in molar %, the total being to 100%:
from 1% to 98% of a lactam selected from lauryllactam, caprolactam, enantholactam, and capryllactam;
from 1% to 98% of a lactam other than the first, selected from lauryllactam, caprolactam, enantholactam, and capryllactam;
from 1% to 98% of a lactone selected from caprolactone, valerolactone, and butyrolactone.

In the case of a copolyesteramide it is advantageous to use caprolactam, lauryllactam, and caprolactone in the following respective proportions (molar): 30-46%, 30-46%, and 8-40% (the total being to 100%).

Preferably the process is applied to lactams and to mixtures thereof rather than to mixtures of two or more lactams and a lactone.

### The Other Ingredients of the Polymerization

An anionic polymerization which is conducted in order to obtain polyamide, copolyamide or copolyesteramide particles is performed in a solvent.

The Solvent

The solvent used dissolves the monomer or monomers but not the particles of polymer which are formed during the polymerization. Examples of solvent are given in patent EP192515. Advantageously the solvent is a paraffinic hydrocarbon fraction with a boiling range at atmospheric pressure of between 120 and 170° C., preferably between 140 and 170° C.

The solvent may be supersaturated with monomer(s) at the initiation temperature, in other words at the temperature at which the polymerization begins. There are various means of supersaturating the solvent with monomer(s). One of these means may involve saturating the solvent with monomer(s) at a temperature greater than the initiation temperature, then lowering the temperature to the initiation temperature. Another means may involve substantially saturating the solvent with monomer(s) at the initiation temperature and then adding, still at the same temperature, a primary amide containing preferably 12 to 22 carbon atoms, such as, for example, oleamide, N-stearamide, erucamide, isostearamide, or else an N,N′-alkylenebisamide, examples of which are given later on.

It is also possible to conduct the polymerization in a solvent which is not supersaturated with monomer(s). In this case the reaction medium contains the monomer or monomers in solution in the solvent at a concentration distant from supersaturation at the initiation temperature.

The Catalyst

A catalyst selected from the catalysts customary for the anionic polymerization of lactams is used. This is a base which is sufficiently strong to give a lactamate after reaction with the lactam or mixture of lactams. A combination of two or more catalysts may be contemplated. Nonlimiting examples include sodium hydride, potassium hydride, sodium, and sodium methoxide and/or ethoxide. The amount of catalyst(s) introduced may in general vary between 0.5 and 3 moles per 100 moles of monomer(s).

The Activator

An activator is added as well, its role being to stimulate and/or accelerate the polymerization. The activator is selected from lactam N-carboxyanilides, (mono)isocyanates, polyisocyanates, carbodiimides, cyanamides, acyllactams and acylcarbamates, triazines, ureas, N-substituted imides, esters, and phosphorus trichloride. It may optionally also be a mixture of two or more activators. The activator may also optionally be formed in situ, for example, by reaction of an alkyl isocyanate with the lactam to give an acyllactam.

The molar catalyst/activator ratio is between 0.2 and 2, preferably between 0.8 and 1.2.

The Amide

Also added is at least one amide, one of which is always an N,N′-alkylenebisamide, as indicated in EP192515. The amount of N,N′-alkylenebisamide(s) introduced is generally of the order of 0.001 to 4 moles, preferably of 0.075 to 2 moles, per 100 moles of monomer(s). The particularly recommended N,N′-alkylenebisamides include the N,N′-alkylenebisamides of fatty acids, and more particularly:
N,N′-Ethylenebisstearamide of formula C₁₇H₃₅—C(═O)—NH—CH₂CH₂—NH—C(═O)—C₁₇H₃₅, abbreviated EBS.
N,N′-Ethylenebisoleamide of formula C17H33-C(═O)—NH—CH2CH2-NH—C(═O)—C17H33, abbreviated EBO.
N,N′-Alkylenebispalmitamide, -gadoleamide, -cetoleamide, and -erucamide.

Preference is given to using EBS and/or EBO.

It is also possible to add a primary amide containing preferably 12 to 22 carbon atoms. It may be selected from the following: oleamide, N-stearamide, isostear-amide, and erucamide.

The Inorganic Filler

The density of the inorganic filler is not more than 4.5 cm3/g and it is selected from silicas, aluminosilicates, aluminum oxides or alumina, titanium dioxides, and BN (for example, Tres BN® from Saint Gobain). It may also be a mixture of these inorganic fillers.

In the case of a mixture of inorganic fillers mentioned above, there may be, by way of example, a mixture of different silicas, a mixture of a silica and an alumina, or else a mixture of a silica and titanium dioxide.

The Organic Filler

The organic filler has a density of not more than 4.5 cm3/g and is a powder of homo- or copolyamide polyamide, preferably of PA12, PA11, PA6, PA6/12, PA 6,12, PA 6,6, PA8, PA4 (for example, Orgasol® powders from Arkema, Vestosint® powders from Degussa, etc.), of polystyrenes, of polyurethanes, of poly(methyl)methacrylates (PMMA), of polyesters, of silicones, of polyethylenes or of polytetrafluoroethylene.

The amount of organic or inorganic fillers and the diameter of said fillers make it possible to influence in the desired direction (small particles or large particles) the size of the eventual particles obtained at the end of the polymerization.

The Other Fillers or Additives

It is also possible to add to the reaction medium any type of fillers (pigments, dyes, carbon black, carbon nanotubes, etc.) or additives (antioxidants, anti-UV agents, plasticizers, etc.) with the proviso that all of these compounds are thoroughly dry and inert with respect to the reaction medium.

### The Polymerization

The anionic polymerization is performed continuously or else, preferably, discontinuously (batchwise). The discontinuous procedure involves introducing the solvent and then, simultaneously or successively, the monomer or monomers, optionally an N,N′-alkylenebisamide, the filler, the catalyst, and the activator. It is advisable first to introduce the solvent and the monomer or monomers and then to remove the water, with the aid for example of azeotropic distillation, and then to add the catalyst when the medium contains as few molecules of water as possible. The filler may be introduced, for example, after the introduction of the monomer or monomers. It may be advantageous, in order to prevent solidification or loss of control of the polymerization, to introduce the activator not in one go at a time t, but either in one go over a shorter or longer interval at a constant rate or with a rate gradient, or in steps, with different rates for each step.

Operation takes place at atmospheric pressure or else under a slightly higher pressure (partial pressure of the hot solvent) and at a temperature between 20° C. and the boiling temperature of the solvent. The temperature of initiation and of polymerization of the lactams is in general between 70 and 150° C., preferably between 80 and 130° C.

The [organic or inorganic filler/monomer or monomers introduced into the reaction medium] weight ratio, expressed in %, is between 0.001% and 65%, preferably between 0.005% and 45%, more preferably between 0.01% and 30%, and advantageously between 0.05% and 20%.

The powders according to the invention may be used in the context of the process of producing articles by melting induced by a laser beam (laser sintering), IR radiation or UV radiation. The technique of laser sintering is described in the applicant's patent application EP1571173.

### THE EXAMPLES

We are now going to give examples of the invention (see tables 1 and 2 below).

Measurement of the Particle Size of the Powders Obtained

The powders obtained in the inventive and comparative examples below are analyzed using a Coulter LS230 granulometer. This gives the particle-size distribution of the powders, from which it is possible to ascertain:
The average diameter.
The breadth of the distribution or the standard deviation of the distribution.

The particle-size distribution of the powders according to the invention is determined by the customary methods, using a Coulter LS230 granulometer from Beckman-Coulter. From the particle-size distribution it is possible to ascertain the volume-average diameter with the logarithmic calculation mode, version 2.11a. of the software, and also the standard deviation, which measures the narrowness of the distribution or the breadth of the distribution around the average diameter. One of the advantages of the process described here is to allow a narrow distribution (low standard deviation) to be obtained in relation to the average diameter. This standard deviation is calculated using the logarithmic statistical calculation mode, version 2.11a. of the software.

Measurement of the Apparent Specific Surface Area (ASSA)

The apparent specific surface area of the particles was measured by the BET method (ten points) with the SA3100 from Beckmann-Coulter. The BET (Brunauer-Emmet-Teller) method is a method which is well known to the skilled worker. It is described in particular in Journal of the American Chemical Society, vol. 60, page 309, February 1938, and corresponds to international standard ISO 5794/1 (annex D). The specific surface area measured by the BET method corresponds to the total specific surface area—that is, it includes the surface formed by the pores. The BET technique involves absorbing a monomolecular layer of gas molecules on the surface. The gas used is nitrogen.

### Examples Seeded with Inorganic Filler

### Table 1 Below

### Example 1

The reactor, maintained under nitrogen, is charged with 2210 ml of solvent and then, in succession, with 719 g of dry lauryllactam, 21.5 g of EBS, 0.45 g of N-stearamide, and 13.8 g of AEROSIL® 8972 finely divided silica. After commencement of stirring at 350 rpm, the mixture is heated gradually to 110° C. and then 265 ml of solvent are distilled off under vacuum in order to entrain, azeotropically, traces of water that might be present.

Following a return to atmospheric pressure, the anionic catalyst and 1.44 g of sodium hydride of 60% purity in oil are introduced rapidly under nitrogen, and the stirring is increased to 650 rpm, under nitrogen at 110° C. for 30 minutes.

Then the temperature is taken to 95° C. and, using a small metering pump, the activator selected, namely stearyl isocyanate (41.3 g made up to 323.2 g with the solvent), is injected continuously into the reaction medium in accordance with the following program:
21.6 q/h of isocyanate solution for 300 minutes;
77.6 g/h of isocyanate solution for 150 minutes.

In parallel the temperature is maintained at 95° C. for the first 300 minutes and then is raised to 120° C. over 30 minutes and maintained at 120° C. for a further 2 hours after the end of introduction of the isocyanate.

The polymerization is then at an end and the reactor is almost clean.

After cooling to 80° C., decanting, and drying, the particle size is between 1. and 20 μm, the average diameter of the particles is 6 μm without agglomerate, and the ASSA is 20.7 m²/g.

### Example 2

Example 1 is reproduced but using 14.5 g of EBS. When the polymerization is at an end, the reactor is almost clean. The particle size is between 1 and 20 μm, the average diameter of the particles is 6.3 μm without agglomerate, and the ASSA is 7.1 m²/g.

Comparing example 1 and example 2, it is observed that the reduction in the amount of EBS results in a large drop in the ASSA for a comparable particle size.

### Example 3

The reactor, maintained under nitrogen, is charged with 2800 ml of solvent and then, in succession, with 899 g of dry lauryllactam, 27.7 g of EBS, 0.45 g of N-stearamide, and 3.6 g of AEROSIL® R972 finely divided silica. After commencement of stirring at 350 rpm, the mixture is heated gradually to 110° C. and then 290 ml of solvent are distilled off under vacuum in order to entrain, azeotropically, traces of water that might be present.

Following a return to atmospheric pressure, the anionic catalyst and 1.44 g of sodium hydride of 60% purity in oil are introduced rapidly under nitrogen, and the stirring is increased to 720 rpm, under nitrogen at 110° C. for 30 minutes.

Then the temperature is taken to 99.7° C. and, using a small metering pump, the activator selected, namely stearyl isocyanate (55.7 g made up to 237.7 g with the solvent), is injected continuously into the reaction medium in accordance with the following program:
14.4 g/h of isocyanate solution for 300 minutes;
%52.1 g/h of isocyanate solution for 175 minutes.

In parallel the temperature is maintained at 99.7° C. for the first 300 minutes and then is raised to 120° C. over 30 minutes and maintained at 120° C. for a further 1 hour after the end of introduction of the isocyanate.

The polymerization is then at an end and the reactor is almost clean. After cooling to 80° C., decanting, and drying, the particle size is between 2 and 25 μm, the average diameter of the particles is 10.0 μm, and the ASSA is 12.2 m²/g without agglomerate.

### Example 4

The conditions used are the same as those for example 3, but without addition of N-stearamide. The polyamide 12 powder obtained has the following characteristics:

Particle size between 2 and 25 μm with the average diameter of the particles being 10.4 μm, and an ASSA of 7.7 m²/g without agglomerates; and the reactor is almost clean.

### Example 5

The reactor, maintained under nitrogen, is charged with 2800 ml of solvent and then, in succession, with 323 g of caprolactam, 575 g of dry lauryllactam, 30.9 g of EBS, and 10.8 g of finely divided silica. After commencement of stirring at 300 rpm, the mixture is heated gradually to 110° C. and then 290 ml of solvent are distilled off under vacuum in order to entrain, azeotropically, traces of water that might be present.

Following a return to atmospheric pressure, the anionic catalyst and 9 g of sodium hydride of 60% purity in oil are introduced rapidly under nitrogen, and the stirring is increased to 720 rpm, under nitrogen at 110° C. for 30 minutes.

Then the temperature is taken to 81° C. and, using a small metering pump, the activator selected, namely stearyl isocyanate (32.9 g made up to 323.9 g with the solvent), is injected continuously into the reaction medium in accordance with the following program:
53.9 g/h of isocyanate solution for 300 minutes.

In parallel the temperature is maintained at 81° C. for the first 300 minutes and then is raised to 110° C. over 60 minutes and maintained at 110° C. for a further 3 hours after the end of introduction of the isocyanate. The polymerization is then at an end and the reactor is almost clean. After cooling to 80° C., decanting, and drying, the particle size is between 2 and 25 μm, the average diameter of the particles is 11.7 μm, and the ASSA is 28.8 m²/g without agglomerate.

### Example 6

Example 5 is reproduced but using 7.2 g of EBS. When the polymerization is at an end, the reactor is almost clean. The particle size is between 2 and 25 μm, the average diameter of the particles is 13.7 μm, and the ASSA is 15.9 m²/g without agglomerate.

Comparing example 5 and example 6, it is observed that the reduction in the amount of EBS results in a large drop in the ASSA for a slight increase in the average diameter.

### Examples Seeded with Organic Fillers

### Table 2 Below

### Example 7

The reactor, maintained under nitrogen, is charged with 2800 ml of solvent and then, in succession, with 108 g of caprolactam, 679 g of dry lauryllactam, 14.4 g of EBS, and 112 g of finely divided ORGASOL® 2001 UD NAT1. After commencement of stirring at 300 rpm, the mixture is heated gradually to 110° C. and then 290 ml of solvent are distilled off under vacuum in order to entrain, azeotropically, traces of water that might be present.

Following a return to atmospheric pressure, the anionic catalyst and 7.2 g of sodium hydride of 60% purity in oil are introduced rapidly under nitrogen, and the stirring is increased to 720 rpm, under nitrogen at 110° C. for 30 minutes.

Then the temperature is taken to 96° C. and, using a small metering pump, the activator selected, namely stearyl isocyanate (32.9 g made up to 314 g with the solvent), is injected continuously into the reaction medium in accordance with the following program:
10 g/h of isocyanate solution for 300 minutes;
88 g/h of isocyanate solution for 180 minutes.

In parallel the temperature is maintained at 96° C. for the first 360 minutes and then is raised to 110° C. over 60 minutes and maintained at 110° C. for a further 2 hours after the end of introduction of the isocyanate.

The polymerization is then at an end and the reactor is almost clean. After cooling to 80° C., decanting, and drying, the particle size is between 2 and 20 μm, the average diameter of the particles is 11.8 μm, and the ASSA is 9.3 m²/g without agglomerate.

### Example 8

Example 7 is reproduced but using 24.7 g of EBS. When the polymerization is at an end, the reactor is almost clean. The particle size is between 1 and 20 μm, the average diameter of the particles is 11.4 μm, without agglomerates, and the ASSA is 13.2 m²/g.

### Example 9

Example 7 is reproduced but using 30.9 g of EBS. When the polymerization is at an end, the reactor is almost clean. The particle size is between 1 and 20 μm, the average diameter of the particles is 11.4 μm, without agglomerate, and the ASSA is 15 m²/g.

Comparing examples 7-9, it is observed that the increase in the amount of EBS results in a large increase in the ASSA for a particle size or an average diameter which is virtually the same or substantially constant.

TABLE 1

| | Ex. 1 | Ex. 2 | Ex. 3 | Ex. 4 | Ex. 5 | Ex. 6 |
|---|---|---|---|---|---|---|
| Lactam 6 | | | | | 323 | 323 |
| Lactam 12 | 719 | 719 | 899 | 899 | 575 | 575 |
| EBS | 21.5 | 14.5 | 27.7 | 27.7 | 30.9 | 7.2 |
| N-Stearamide | 0.45 | 0.45 | 0.45 | | | |
| Silica | 13.8 | 13.8 | 3.6 | 3.6 | 10.8 | 10.8 |
| Stearyl isocyanate | 41.3 | 41.3 | 55.7 | 55.7 | 32.9 | 32.9 |
| NaH | 1.44 | 1.44 | 1.44 | 1.44 | 9 | 9 |
| Average | 6 | 6.3 | 10 | 10.4 | 11.7 | 13.7 |
| diameter (μm) | | | | | | |
| ASSA (m²/g) | 20.7 | 7.1 | 12.2 | 7.7 | 28.8 | 15.9 |

TABLE 2

| | Ex. 7 | Ex. 8 | Ex. 9 |
|---|---|---|---|
| Lactam 6 (g) | 108 | 108 | 108 |
| Lactam 12 (g) | 679 | 679 | 679 |
| EBS (g) | 14.4 | 24.7 | 30.9 |
| Organic filler (g) | 112 | 112 | 112 |
| EBS/lactam | 54.65 | 31.86 | 25.47 |
| Stearyl isocyanate | 32.9 | 32.9 | 32.9 |
| NaH | 7.2 | 7.2 | 7.2 |
| Average diameter (μm) | 11.8 | 11.4 | 11.4 |
| ASSA (m²/g) | 9.3 | 13.2 | 15 |

1. A process for preparing a polymer powder selected from a polyamide, a copolyamide or a copolyesteramide, by anionic polymerization in a solvent solution, comprising polymerizing a constituent monomer or monomers in the presence:
of a catalyst,
of an activator,
of at least one amide selected from N,N′-alkylenebisamides, and
of an organic or inorganic filler with a maximum density of 4.5 cm3/g, to form polymer particles,
the amount of amide added being determined as a function of either:
a) the desired Apparent Specific Surface Area (ASSA) for the formed powder particles, said powder particles having a substantially constant diameter; or
b) the desired average polymer particle diameter, said powder particles having a substantially constant Apparent Specific Surface Area (ASSA).

2. (canceled)

3. The process of claim 1, wherein, when the amount of amide goes up, the ASSA goes up.

4. The process of claim 1, wherein, when the amount of amide goes up, the average diameter goes down.

5. The process of claim 1, wherein the constituent monomer or monomers of the polymer is or are selected from the group consisting of lactams, lauryllactam, caprolactam, enantholactam, capryllactam or mixtures thereof.

6. The process of claim 1, wherein the constituent monomers of the polymer are a mixture comprising in molar %, the total being to 100%:
from 1% to 98% of a lactam selected from lauryllactam, caprolactam, enantholactam, and capryllactam;
from 1% to 98% of a lactam other than the first, selected from lauryllactam, caprolactam, enantholactam, and capryllactam;
from 1% to 98% of a lactone selected from caprolactone, valerolactone, and butyrolactone.

7. The process of claim 1, wherein the catalyst is selected from sodium hydride, potassium hydride, sodium, and sodium methoxide and ethoxide.

8. The process of claim 1, wherein the activator is selected from lactam N-carboxyanilides, (mono)isocyanates, polyisocyanates, carbodiimides, cyanamides, acyllactams and acylcarbamates, triazines, ureas, N-substituted imides, esters, and phosphorus trichloride.

9. The process of claim 1, wherein the N,N′-alkylenebisamide is selected from N,N′-ethylenebisstearamide (EBS) and N,N′-ethylenebisoleamide (EBO).

10. The process of claim 1, wherein the inorganic filler is selected from silicas, aluminosilicates, aluminum oxides or alumina, titanium dioxides, and BN.

11. The process of claim 1, wherein the organic filler is selected from the group consisting of homo- or co-polyamide powders; powders of PA12, PA11, PA6, PA6-12, PA 6,12, PA 6,6, PA8, PA4 polystyrenes, polyurethanes, poly(methyl)methacrylates (PMMA), polyacrylates, polyesters, silicones, polyethylenes, and polytetrafluoroethylene.

12. The process of claim 1, wherein the distribution of the particles is narrower when an organic filler is used in the process than when an inorganic filler is used.

13. The process of claim 1, wherein the powder particles obtained have an average diameter <30 microns.

14. The process of claim 1, wherein the ASSA <40 m2/g.

15. Polymer powder particle composition wherein said particles are selected from a polyamide, a copolyamide or a copolyesteramide obtained as claimed in claim 11.

16. The particle composition of claim 15, wherein the organic filler is PA12, PA11, PA6, PA6/12, PA 6,12, PA 6,6, PA8, or PA4.

17. The particle composition of claim 15, further comprising at least one compound selected from the group consisting of carbon nanotubes, metal particles, pigments, dyes, antioxidants, anti-UV agents, plasticizers, and carbon black.

18. The particle composition of claim 11 comprising composite materials, transfer papers, substrate coatings, particularly on metallic substrates (coil coating), solid or liquid paint or ink compositions, cosmetic compositions and/or pharmaceutical compositions.

19. The particle composition of claim 11 comprising articles formed by agglomeration of said powder composition, by compression by sintering, melting. or by laser sintering
